(19) United States
(12) Patent Application Publication
(10) Pub. No.: US 2026/0231962 A1
(43) Pub. Date: Aug. 13, 2026

(54) EDIBLE PRIMER FOR ABSORBENT FOOD PRODUCTS

(71) Applicant: SUN CHEMICAL B.V., Weesp (NL)

(72) Inventors: Paul Andrew WALLACE, Derbyshire (GB); Jeffrey KENNEDY, Amelia, OH (US); Andrew BALCH, Midsomer Norton (GB)

(73) Assignee: SUN CHEMICAL B.V., Weesp (NL)

(21) Appl. No.: 19/470,701

(22) PCT Filed: Apr. 24, 2024
(86) PCT No.: PCT/GB2024/051069

§ 371 Date: Sep. 29, 2025

Related U.S. Application Data
(60) Provisional application No. 63/461,388, filed on Apr. 24, 2023.

(51) Int. Cl. A21D 13/28; A21D 13/47; A21D 13/80; A23L 29/212; A23L 29/231; A23P 20/10; A23P 20/20; A23P 20/25

(52) U.S. Cl. CPC A21D 13/28; A21D 13/47; A21D 13/80; A23L 29/212; A23L 29/231; A23P 20/10; A23P 20/20; A23P 2020/253

(57) ABSTRACT

A method for decorating a foodstuff, comprising:
a. providing a foodstuff base layer;
b. applying an edible liquid primer to the surface of the foodstuff, wherein the primer comprises pectin; insoluble, edible particles; and water;
c. drying the primer layer;
d. printing one or more edible inkjet inks over the top of the primer layer;
e. drying the one or more inkjet ink layers;
   to produce a finished, decorated foodstuff.

The present invention relates to an edible liquid primer for applying to a foodstuff, wherein the edible primer comprises solid particles. The present invention also relates to a method for decorating a foodstuff comprising applying said edible liquid primer to a surface of the foodstuff.

### BACKGROUND OF THE INVENTION

US20090186121 A1 (Sensient) mentions that a coating containing a combination of maltodextrin and hydroxypropylmethylcellulose (HPMC) can be used to coat areas of a foodstuff, which help to improve the image quality of edible inkjet inks printed on at least a portion of the surface coated with the coating. The coating is a solid mixture applied directly to food items. No mention is made of color strength, only of image quality.

KR100418829 B1 (Toppan) mentions using an aqueous solution of glycerol as a pre-treatment for the subsequent decoration of foods by inkjet printing.

DE102017001108 A1 (Merck) mentions that a composition including water, stabilizer, moisture regulator and emulsifier can be used for producing an edible decorative element for food. In all cases, the preferred stabilizer is colloidal microcrystalline cellulose, preferably carboxymethyl cellulose (CMC) and particularly preferably sodium carboxymethyl cellulose. The composition also includes whitening agents, such as alumina, silica or titania. The inclusion of whitening agents will affect the visual appearance of the food item, such as bread, and might cause a texture change in a food item, potentially leading to a poorly perceived consumer experience.

KR20020057498 A (Yetek) mentions the use of a pre-treatment liquid for foods consisting of water, glycerine, starch syrup and alcohol. This is another example of a solution primer but would not be very effective for highly absorbent media such as bread or cookies.

EP1842432 A1 & US20070237869 A1 (Akutagawa Confectionary) mention the general principle that an oil-containing foodstuff, for example chocolate, can be coated with a white or opaque coating which acts to form a print receptive layer for subsequent over-printing with edible inkjet inks. The opacity or whiteness of the dried primer will likely cause an unnatural visual appearance of the food item.

The primer coatings described in the art are applied to provide a white or significantly opaque finish. None of the cited formulations for the primer layer contain the combination of ingredients in the present application. Furthermore, there is no reference to using a coloured ink set for image formation to be printed subsequently on the primer layers, where the coloured ink set also may a white ink. In a significant number of food applications, such as cookies, biscuits, baked breads and bakery products, and porous food articles such as wafers, a white background is not particularly attractive, especially if it is opaque.

Pre-treatment liquid formulations which can be used to impart either a transparent or translucent film on a food object prior to subsequent decoration by inkjet printing are not described in the art. Furthermore, the formulations described in the art are not suitable for use on porous foods such as baked goods, breads, doughs, cakes, fondants, etc.

Citation or identification of any document in this application is not an admission that such represents prior art to the present invention.

### SUMMARY OF THE INVENTION

The present invention relates to a method for decorating a foodstuff, comprising:
a. providing a foodstuff base layer;
b. applying an edible liquid primer to the surface of the foodstuff, wherein the primer comprises pectin; insoluble, edible particles; and water;
c. drying the primer layer;
d. printing one or more edible inkjet inks over the top of the primer layer;
e. drying the one or more inkjet ink layers;

to produce a finished, decorated foodstuff.

The present invention also relates to a liquid primer composition comprising:
a. pectin;
b. insoluble, edible particles; and
c. water; and
   wherein the composition is edible.

The present invention also relates to a decorated foodstuff prepared by the method of the invention.

The present invention also relates to a decorated foodstuff comprising a primer of the invention or a primer derived from the primer of the invention.

The present invention also relates to use of a liquid composition as a primer for pre-treating a foodstuff, wherein said liquid composition comprises pectin, insoluble, edible particles and water.

### DETAILED DESCRIPTION

The present invention relates to a primer liquid which can be applied to foodstuffs, particularly baked goods such as breads and cakes, which are typically difficult to decorate with edible inkjet inks without such a primer layer in place. The formulations (i.e., primer liquid) give a pre-treatment chemistry which provides suitable adhesion of edible inkjet inks on porous foods. As will be understood, porous foods are those having pores or holes through which liquid or air can pass, for example, bread and cakes. The foods that are particularly suitable for use in the present invention are absorbent. In some instances, the food is fully absorbent. In other instances, the food is only partially absorbent (or semi-absorbent).

The present invention also relates to a method for decorating a foodstuff, comprising providing a foodstuff base layer; applying an edible primer as defined herein to the surface of the foodstuff; drying the primer layer; printing one or more edible inkjet inks over the top of the primer layer; drying the one or more inkjet ink layers to produce a finished, decorated foodstuff. As used herein, a foodstuff base layer refers to a foodstuff on which the edible primer is applied.

Preferably, the primers of the present invention are applied directly to the surface of a foodstuff. As will be understood in the art, the primers are applied directly to the surface of the foodstuff where there is no intermediary layer between the foodstuff and the primer. Preferably, the primers provide a suitable pre-treatment layer on the foodstuff, which means that the foodstuff does not typically require any pre-treatment before application of the primer.

Preferably, the primer of the present invention is applied by spray coating, nozzle coating, slot coating, brush coating or inkjet printing.

Advantageously, the primer is easy to apply, dries quickly, and can be used to provide pre-treatment coatings which are transparent or translucent. Application of the primer can be made, for example, using a spraying process, for example using a bottle with a trigger spray or a spray nozzle or any other spray process. Application of the primer can also be carried out by dipping or digital printing or any other suitable application method. The primer can then be either air-dried, or more advantageously dried at elevated temperature (e.g., >100° C.) to speed up the drying process. Preferably, the primer is applied to warm or hot baked items as they emerge from an oven as part of an in-line baking/primer application process. Preferably, the process can further include a digital printing step as part of an in-line baking/primer/printing process.

The application of the primer to the foodstuff enables them to be subsequently digitally printed with good image resolution and colour strength using edible inkjet inks, even when contoured or with a 3D definition. Preferably, edible inkjet inks, such as those commercially available from Sun Chemical, can be used to decorate the primed food objects (i.e., foodstuff) with full colour images, including white or effects. Preferably, the foodstuff containing the primer and subsequent inkjet ink layer(s), could subsequently be printed with an edible overprint varnish, which could simply be a further layer of the edible primer.

The present inventors have found that primer treatment liquids which contain solid particles from either a solid dispersion or emulsion provide superior performance on absorbent food items vs. those that only contain a dissolved edible polymer.

Without wishing to be bound in this regard, the present inventors believe that the use of pectin in combination with solid, insoluble, edible particles essentially plug the microcavities on the surface of the food objects providing a suitable flat surface which can subsequently be overprinted with inkjet inks to provide good image and colour quality. The primers advantageously dry to clear (transparent) or translucent films on the surface of the food object. It is also believed that the filling in (i.e., plugging) of the microcavities prevents or lessens the absorption of the subsequently applied digitally printed inks into the foodstuff, resulting in improved print appearance and colour strength. Preferably, the primers of the present invention, when dried, are not visible or are minimally visible on the surface of the food item to prevent possible unwanted visual discoloration of the food item.

As will be understood, there is no limitation on the viscosity of the primer so long as it can be applied by the chosen application method. Preferably, the primers have a viscosity of 0.1 mPas-2,8000 mPas, more preferably, the primers have a viscosity of 10 mPas (0.1 Poise)-1500 mPas (15 Poise), such that they are readily sprayable from traditional hand-held trigger spray bottles or industrial spray coating nozzles.

The viscosity of the primers can be suitably measured using a Brookfield DVI viscometer using an LCP spindle (10 rpm) and adapter at 25° C. or using a Brookfield DV-II+ viscometer (#8 spindle, 25° C., 100 rpm). Each of these viscometers can suitably be calibrated using an oil standard that gives a measurement of 5 cP (5 mPas) at 25° C. and 10 cP at 50° C. in accordance with ASTM D445-24.

In some cases, the primers preferably have a viscosity of 10 mPas-1500 mPas when measure using a Brookfield DVI viscometer using an LCP spindle (10 rpm) and adapter at 25° C. In other alternative cases, the primers preferably have a viscosity of 10 mPas-1500 mPas when measure using a Brookfield DV-II+ viscometer (#8 spindle, 25° C., 100 rpm).

Alternatively, the primers can preferably be applied by a pastry brush or any other food application or dispensing method. When applied by brushing, there is no limitation on viscosity so long as the primer is in a liquid state.

Preferably, the primers of the present invention have a static surface tension in the range 25-50 dynes/cm to help ensure even distribution across the surface of the baked goods. More preferably, the primers of the present invention have a static surface tension of from about 25 to about 40 dynes/cm. Unless stated otherwise, surface tension is measured using an AquaPi tensiometer (from Kibron) at room temperature.

Preferably, the primers of the present invention are applied directly on to the surface of a foodstuff by spray-coating or brushing.

Preferably, the primers of the present invention are applied, for example by spray coating or brushing, directly onto hot or warm baked goods (immediately after the food baking process) as the heat retained in the baked goods may be sufficient to dry the primer liquids within a matter of seconds (e.g., less than 20 seconds) such that they can be immediately decorated, for example by inkjet printing, with edible inkjet inks. While the primers can also be applied to room temperature or cold food objects, the primer layer subsequently requires drying either by ambient temperature or hot air, for example in an oven or using a hot air knife. Thus, it is preferred that the primer is applied to warm or hot baked goods immediately after baking (i.e., within 1-3 minutes of the food product emerging from an oven, preferably a 150-200° C. oven) to allow for an in-line conveyor process wherein the baked goods exiting the baking phase can immediately be spray coated with the primers and proceed directly to a printing station for decoration. Preferably, the printing station is inkjet.

Where the primer is heat-dried, it is preferably dried at temperatures>100° C. Preferably, the primer is heat-dried at 100-200° C., more preferably 150-200° C.

Examples of pectin which can be employed in this invention include high methoxyl (HM) pectin, low methoxyl (LM) pectin, citrus pectin, apple pectin, amidated low methoxyl pectin and pectin NH. As will be understood, in some cases, LM pectin can be sourced from citrus peels. An example of a commercially available LM pectin that is sourced from citrus peels is pectin e440i from Modernist Pantry. Apple pectin suitable for use in the present invention is available from, for example, Sigma Aldrich.

Preferably, the primers of the invention comprise LM pectin or apple pectin.

The edible primer according to the present invention is a liquid primer comprising pectin insoluble, edible particles and water. As will be understood, the edible particles are insoluble in the liquid primer carrier, which comprises pectin and water. In some instances, the edible particles may also be insoluble in water, but this is not essential for the present invention. Preferably, the liquid primer comprises pectin and water in a ratio of from about 1:100 to about 1:10 (w/w). More preferably, the liquid primer comprises pectin and water in a ratio of from about 1:38 to about 1:12, even more preferably from about 1:30 to about 1:15.

Preferably, the primers of the present invention comprise from about 1 to about 10 wt % pectin, preferably from about 2.5 wt % to about 7.5 wt %, more preferably from about 3 wt % to 6 wt % (based on the total weight of the primer).

Preferably, the edible particles used in the present invention are derived from milk and/or edible carbohydrates. As used herein, unless stated otherwise, milk includes mammalian milk and plant-based milk.

Preferably, the edible particles used in the present invention are derived from milk, wherein milk refers to mammalian milk and plant-based milk. Examples of mammalian milk that are suitable for use in the present invention include cow milk, sheep milk and goat milk. Examples of plant-based milk that are suitable for use in the present invention include coconut milk, soy milk, almond milk, oat milk and rice milk. Accordingly, the edible particles used in the present invention are preferably derived from cow milk, sheep milk, goat milk, coconut milk, soy milk, almond milk, oat milk and rice milk. More preferably, the edible particles used in the present invention are derived from cow milk or coconut milk.

Preferably, the edible particles used in the present invention are proteinaceous solids derived from milk, wherein milk refers to mammalian milk and plant-based milk. Preferably, the edible particles used in the present invention are proteinaceous solids derived from cow milk or coconut milk.

As will be understood, the edible particles used in the present invention are solid.

The solid insoluble edible particles can be selected from the group consisting of coffee creamer powder, milk powder, whey powder, cheese powder, coconut powder and combinations thereof. As will be understood, coffee creamer powder, milk powder, whey powder and cheese powder can be suitably derived from mammalian milk (typically cow milk) and coconut powder can be suitably derived from coconut milk.

An example of coffee creamer powder suitable for use in the present invention is Nestle coffeemate.

Preferably, the insoluble, edible particles are derived from edible carbohydrates. Examples of suitable edible carbohydrates include potatoes, bread, legumes (e.g., beans, peas, lentils) and cereals (e.g., rice, wheat, rye, barely, oats, millet and maize). More preferably, the insoluble, edible particles are derived from cereals such as rice, wheat, rye, barely, oats, millet and maize. More preferably, the insoluble, edible particles are derived from maize.

Preferably, the insoluble, edible particles are derived from edible carbohydrates and comprise starch. More preferably, the insoluble, edible particles are starch.

Suitable starches that can be used in the present invention includes corn starch, maize starch, tapioca starch, modified starch and combinations thereof. Preferably, the starch is a modified starch such as modified corn starch, modified maize starch, modified tapioca starch and combinations thereof. Modified starch includes starch that has been reacted with carboxylic acids or anhydrides to afford a product comprising carboxylic acid salts as substituents, for example, starch sodium octenylsuccinate. More preferably, the insoluble, edible particles are modified maize starch.

The solid insoluble edible particles can optionally be in the form of a dispersion or an oil in water emulsion, for example, an aqueous dispersion comprising said solid insoluble edible particles or an oil in water emulsion comprising said solid insoluble particles dispersed therein.

Preferably, the edible particles used in the present invention are derived from plant-based products. One particularly preferred material is Sunfoods Natural White WL, a plant-based product. Preferably, the edible particle is Sunfoods Natural White WL. Sunfoods Natural White WL is a sub-micron (≤1 micron) dispersion in water and oil and therefore described as an opacifying emulsion. It is a natural alternative to titanium dioxide, primarily designed for beverages and foods. A further advantage of this material is its ability to dry to a clear film when diluted for a more desirable appearance compared to a white or cloudy film.

Typically, Sunfoods Natural White WL has a solids content of 20% (w/w) and an oil content of 20% in water.

Preferably, the primers of the present invention comprise 0.5 to 20% (by dry weight) of edible particles, more preferably from about 1 to about 10% (by dry weight) and even more preferably from 1.5 to 8% (by dry weight).

Preferably, the primers of the present invention are substantially free (i.e., comprise less than 0.5 wt %) of whitening agents. Typical whitening agents include aluminium dioxide, silicon dioxide, calcium carbonate and titanium dioxide. Preferably, the primers of the present invention are substantially free (i.e., comprise less than 0.5 wt %) of aluminium dioxide, silicon dioxide, calcium carbonate, titanium dioxide and/or combinations thereof. More preferably, the primers of the present invention are free of whitening agents. More preferably, the primers of the present invention are free of aluminium dioxide, silicon dioxide, calcium carbonate, titanium dioxide and/or combinations thereof.

Advantageously, the primers of the present invention are stable (resistant to gelation). For the purposes of the present application, a primer is considered stable if it remains in a liquid state 3 months after manufacture. All of the primers in Table 1 were assessed 3 months after manufacture and found to be in a liquid state (not gelled).

The use of calcium ions to gel high methoxyl pectin solutions is well documented in the literature. Therefore, when preparing high methoxyl pectin based particulate primers containing particulates with a high calcium content, the stability may be compromised. In such cases, it may be advantageous to freshly prepare the primer immediately before use (i.e., within 24 hr) to ensure useability.

The particle size of the particulate matter in the primer is not critical. Accordingly, the edible particles used in the present invention have a wide range of particle sizes. For example, the edible primers can be tenths or hundredths of microns, or even larger in size.

For spray applications the particulate matter should be suitably small to ensure that the primer does not block any nozzle used to applied it. Since there is a wide range of nozzle apertures used for spray applications, the particle size of the particulate matter in the primer may also be of a wide range, for example up to 500 microns or even potentially larger.

Preferably, the edible particles used in the primer of the invention have a particle size of from about 100 to about 800 microns, preferably from about 200 to about 700 microns, more preferably from about 300 to about 600 microns.

Alternatively, the edible particles used in the primer of the invention preferably have a particle size of ≤500 microns. Preferably, the edible particles used in the primer of the invention have a particle size of from about 10 to 500 microns, preferably from about 50 to 500 microns.

Preferably, the particulate matter (i.e., the solid edible particles) can be easily mixed into water and are capable of easily redispersing immediately before use by shaking or stirring to counteract any settling, thereby allowing a uniform application of primer to the food item.

Preferably, the edible particles used in the present invention are insoluble in water.

The particulate materials (i.e., the solid edible particles) are preferably water-insoluble and a wide range of particle sizes can be used, such as for example tenths or hundredths of microns, or even larger. When applied using a spray operation, the particle size when dispersed in the other ingredients of the primer formulations, should be suitable for dispensing through nozzle trigger spray bottles and the like without clogging.

The insoluble edible particles (which are preferably water-insoluble particles) are fundamental to the present invention as when they are used in the described primer formulations, which are preferably mixed prior to application to foodstuffs, they provide a relatively even coating on the surface of the food product and act to plug the pores or holes in the top surface layers of the food articles, making them receptive to overprinting, for example by inkjet.

Advantageously, the particles are stable in the primer formulations (resistance to settling). Accordingly, the primers of the invention typically have good shelf life. This was demonstrated by measuring the standard stability of the primer formulations at room temperature and accelerated temperature (40° C. and 60° C.). Standard stability is typically measured by storing the primer formulations at room temperature for 1 year, at 40° C. for 24 weeks and at 60° C. for 12 weeks, and measuring suitable physical properties (e.g., particle size, viscosity, etc.) weekly. The particles are considered stable (resistant to settling) if there is less than 10% change in the measured physical properties over test duration.

Optionally, other materials that can be used in the primer formulations are as follows: surfactants, wetting agents, preservatives, pH modifiers, co-solvents and combinations thereof.

Surfactants that can be used in the primers of the invention include those which are compliant with food regulations (i.e., food-compliant). Preferably, where used, the surfactant is a nonionic surfactant, more preferably a food-compliant nonionic surfactant. Suitable food-compliant surfactants that can be used include various polysorbates, phytosterol, lecithins, lanolins, cholesterols, carrageenan, alkyl glycosides, beeswax, coconut oil and blends thereof. Preferred food-compliant surfactants include various polysorbates, phytosterol, lecithins, lanolins, cholesterols, carrageenan or alkyl glycosides. Preferably, the primer of the present invention comprises a polysorbate such as polysorbate 80. Where used, the surfactant is preferably present in from about 0.1 to about 2 wt % of the total composition.

Wetting agents that can be used in the primers of the invention include a single component or a blend of food safe mono-, di- and triglycerides of caprylic and capric acid derived from vegetable sources, for example, Capmul MCM. The inclusion of the wetting agent helps the primer spread across food items while minimizing surface irregularities to help maintain printed ink image quality. Where used, the wetting agent is preferably present in from about 0.1 to about 2 wt % of the total composition.

Preservatives that can be used in the primers of the invention include any of those commonly used in food additives, for example sorbic acid and sorbate compounds (including sorbate K), benzoic acid and benzoate compounds, natamycin, propionic acid and propionate compounds, ascorbic acid and ascorbate compounds, tocopherol, butylated hydroxyanisole (BHA) and butylated hydroxytoluene (BHT), citric acids, sorbic acid and sorbate compounds. Where used, the preservative is preferably present in from about 0.1 to about 2 wt % of the total composition.

pH modifiers that can be used in the primers of the invention include, for example food safe pH adjustment agents such as citric acid and citric acid salts, acetic acid and acetic acid salts and ascorbic acid and ascorbic acid salts. Preferably, the pH modifier is citric acid. Where used, the pH modifier is preferably present in from about 0.05 to about 2 wt % of the total composition.

Co-solvents that can be used in the primers of the invention include glycerine and propylene glycol. Where used, co-solvents are preferably present in from about 1 to about 30 wt %.

The primer composition of the present invention preferably comprises from about 60 to about 97 wt % water, more preferably from about 70 to about 97 wt % water, even more preferably from 80 to about 97 wt % water.

In an alternative optional aspect of the invention, the primer composition can be a concentrate. Preferably, the primer composition concentrate comprises pectin, insoluble edible particles, and water, wherein the water is present in 25-50 wt % of the concentrate. As will be understood, the primer composition concentrate can be diluted with, for example, water before use in the method of the invention.

### Foodstuffs

Preferably, the primer of the present invention is applied to a porous foodstuff. The primer of the present invention is particularly suitable for application to porous foodstuffs that are absorbent. The primer of the present invention is also suitable for application to foodstuffs having a contoured and/or irregular surface, for example, a porous foodstuff having a contoured and/or irregular surface.

Preferred foodstuffs that are suitable for use in the present invention are doughs and baked goods such as bread (including bread rolls), pastries, biscuits (cookies), cakes, wafers and pies etc. The invention is also suitable for the decoration of icing and fondant, in which case the foodstuff is considered as the icing or the fondant and the primer is applied directly to said icing or fondant.

### Definitions

Edible=any item that is safe for humans to eat, i.e., any item that can be consumed and digested by a consumer and that does not cause adverse effects to the health of said consumer.
Insoluble, edible particles=as used herein the insoluble, edible particles are insoluble in the liquid primer carrier, which comprises pectin and water. The insoluble edible particles are not necessarily insoluble in any of the individual components that make up the liquid primer (e.g., water). Although, in some instances the edible particles may also be insoluble in water.
Insoluble=for the purposes of the present invention, and unless stated otherwise, a material is insoluble if it has a solubility of less than 0.1% (i.e., less than 0.1 g of material will dissolve in 100 g of liquid carrier at 20° C.
Food-compliant=complies with FDA regulation CFR Part 21 and/or the corresponding EU food regulation EC 1333/2008.
Milk powder=dried milk powder.
Coffee creamer powder=composition comprising corn syrup solids, hydrogenated vegetable oil (coconut and/or palm kernel and/or soybean), sodium caseinate, 2% or less of dipotassium phosphate, sodium aluminosilicate, mono- and diglycerides, artificial flavor, annatto color.
Whey Powder=powder comprising beta-lactoglobulin, alpha-lactalbumin, glycomacropeptide, immunoglobulins, bovine serum albumin (NSA).
Cheese Powder=composition comprising milk powder, cheese, salt, emulsifier E339, anti-caking agent E551, colouring (E102, E110), modified starch, buttermilk, whey protein, maltodextrin, lactose, wheat flour, palm fat, palm oil, E332 (ii), E270, E471, citric acid, monosodium glutamate, edible gum, dextrose monohydrate, yeast extract, sodium inosinate and guanylate.
Coconut Powder=composition comprising dried coconut milk and emulsifiers.
Citrem=a citric acid ester of mono- and diglycerides.
Pectin=a naturally occurring substance (polysaccharide) found in fruits, including berries, apples and citrus fruits. Pectin typically has a weight average molecular weight of 50,000 to 180,000 Da.
HM pectin=high methoxyl pectin, i.e., pectin that has a level of esterification of 50% or more, such that 50% or more of the acid groups on the polysaccharide rings are esterified. Typically, HM pectin is thermally reversible.
LM pectin=low methoxyl pectin, i.e., pectin that has a level of esterification of less than 50%, such that less than 50% of the acid groups on the polysaccharide rings are esterified. Typically, LM pectin is thermally reversible.
Pectin NH=a composition comprising amidated low methoxyl pectin. In some cases, pectin NH may also comprise calcium phosphate. As will be understood in the art, pectin NH is thermally reversible, i.e., it can be melted, set, remelted and then reset again.
Amidated low methoxyl pectin=pectin that has a level of esterification of less than 50% and in addition at least a further 10% of the acid groups on the polysaccharide rings are amidated.
Apple pectin=as used herein, unless stated otherwise, apple pectin refers to poly-D-galacturonic acid methyl ester (CAS Number: 9000-69-5), having a level of esterification of 50-75%.
Citrus pectin=as used herein, unless stated otherwise, citrus pectin is sourced from the peels of citrus fruits. The citrus peel pectin used herein is LM pectin.
DI water=deionized water.
Particle size/average particle size=in the context of the present invention, the terms “particle size” or “average particle size” refer to the volume distributed median particle diameter (equivalent spherical diameter corresponding to 50% of the volume of all the particles, read on the cumulative distribution curve relating volume % to the diameter of the particles-often referred to as the “D(v,0.5)” value). Particle size distributions can be determined by routine laser diffraction techniques. Unless otherwise stated, particle size distribution measurements as specified or reported herein are as measured by Malvern Instruments' conventional Malvern Mastersizer 3000 particle size analyzer.
Molecular Weight=in the context of the present invention the terms “molecular weight” or “average molecular weight” is a reference to the weight average molecular weight (Mw). Unless stated otherwise, the molecular weight is suitably measured by gel permeation chromatography by comparison with a polystyrene standard. For instance, molecular weight determination may be conducted on a Hewlett-Packard 1050 Series HPLC system equipped with two GPC Ultrastyragel columns, 103 and 104 Å (5 μm mixed, 300 mm×19 mm, Waters Millipore Corporation, Milford, MA, USA) and THE as mobile phase. The flow rate in the columns is 1.0 ml/min, column temperature is 40° C., a differential refractive index detector (RI) and a UV-detector (254 nm) were used. The skilled person will appreciate that this definition of molecular weight applies to polymeric materials which typically have a molecular weight distribution.

Unless otherwise stated, all percentages (%) are weight percentages (wt %) relative to the total weight of the respective composition.

Unless otherwise stated, room/ambient temperature is 20° C.
Boiling point=unless otherwise specified, all boiling points are measured under standard atmospheric pressure of 101 kPa.

### Numbered Paragraphs of the Invention

The present invention is further illustrated by the following set of numbered paragraphs and combinations of numbered paragraphs resulting from the dependencies and back-references as indicated. In particular, it is noted that in each instance where a range of paragraphs is mentioned, for example in the context of a term such as “The method of any one of paragraphs 1 to 5”, every paragraph in this range is meant to be explicitly disclosed for the skilled person, i.e. the wording of this term is to be understood by the skilled person as being synonymous to “The method of any one of paragraphs 1, 2, 3, 4 and 5”. Further, it is explicitly noted that the following set of paragraphs represents a suitably structured part of the description directed to general and specific aspects of the present invention.

The invention is further described by the following numbered paragraphs:
1. A method for decorating a foodstuff, comprising:
   a. providing a foodstuff base layer;
   b. applying an edible primer to the surface of the foodstuff;
   c. drying the primer layer;
   d. printing one or more edible inkjet inks over the top of the primer layer;
   e. drying the one or more inkjet ink layers;
   to produce a finished, decorated foodstuff.
2. The method of paragraph 1, wherein the primer comprises pectin; insoluble, edible particles; and water.
3. The method of any preceding paragraph, wherein the primer has a surface tension of 25-50 dynes/cm.
4. The method of paragraph 2, wherein the insoluble, edible particles are selected from the group consisting of opacifying emulsions, coffee creamer powder, milk powder, whey powder, cheese powder, coconut powder and mixtures thereof.
5. The method of any preceding paragraph, wherein the primer further comprises one or more additives selected from the group consisting of food compliant surfactants, preservatives, wetting agents, pH modifiers and co-solvents.
6. The method of paragraph 2, wherein the pectin is selected from the group consisting of high methoxyl (HM) pectin, low methoxyl (LM) pectin, apple pectin, pectin NH and mixtures thereof.
7. The method of any preceding paragraph, wherein the primer is applied by a method selected from the group consisting of spray coating, nozzle coating, slot coating, brush coating and inkjet printing.
8. The method of any preceding paragraph, wherein the primer dries to a transparent or translucent film.
9. The method of any preceding paragraph, wherein the primer is applied to a warm or hot foodstuff.
10. The method of any preceding paragraph, wherein the primer is applied as part of an in-line continuous process to the surface of the foodstuff as it emerges from a baking oven.
11. The method of any preceding paragraph, wherein an overprint varnish is applied over the top of the one or more edible inkjet inks.
12. The method of any preceding paragraph, wherein the primer is either air-dried or heat dried.
13. The method of any preceding paragraph, further comprising applying an edible overprint varnish over the top of the inkjet ink layers and drying the overprint varnish.
14. The method of any preceding paragraph, wherein the foodstuff is an absorbent or porous article.
15. The method of any preceding paragraph, wherein the foodstuff comprises a baked good.
16. The method or paragraph 14, wherein the baked good is selected from the group consisting of breads, doughs, pastries, biscuits, icing, cakes, cookies, pies and fondants.
17. A liquid primer composition comprising:
   a. pectin;
   b. insoluble, edible particles; and
   c. water; and
   wherein the composition is edible.
18. The primer of paragraph 17, where the pectin is selected from the group consisting of high methoxyl (HM) pectin, low methoxyl (LM) pectin, apple pectin, pectin NH and blends thereof.
19. The primer of paragraph 17 or 18, where the edible particles are selected from the group consisting of coffee creamer powder, milk powder, whey powder, cheese powder, coconut powder or other such dispersions containing particles or oil in water emulsions and blends thereof.
20. The primer of any or more of paragraphs 17-19, further comprising one or more materials selected from the group consisting of food compliant surfactants, preservatives, wetting agents, pH modifiers and co-solvents.
21. The primer of paragraph 20, wherein the surfactant is selected from the group consisting of food compliant polysorbates, phytosterol, lecithins, lanolins, cholesterols, carrageenan, alkyl glycosides, beeswax, coconut oil and blends thereof.
22. The primer of paragraph 20, wherein the wetting agent is selected from the group consisting of food compliant mono-, di- and triglycerides of caprylic and capric acid derived from vegetable sources and blends thereof.
23. The primer of paragraph 20, wherein the preservative is selected from the group consisting of food compliant sorbic acid and sorbate compounds, benzoic acid and benzoate compounds, natamycin, propionic acid and propionate compounds, ascorbic acid and ascorbate compounds, tocopherol, butylated hydroxyanisole (BHA) and butylated hydroxytoluene (BHT), citric acids, sorbic acid and sorbate compounds and blends thereof.
24. The primer of paragraph 20, wherein the pH modifier is selected from the group consisting of food compliant citric acid and citric acid salts, acetic acid and acetic acid salts, ascorbic acid and ascorbic acid salts and blends thereof.
25. The primer of paragraph 20, wherein the co-solvent comprises glycerine or propylene glycol.

The present invention has been described in detail, including various embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples which further illustrate the invention, and are not intended, nor should they be interpreted to, limit the scope of the invention.

### Preparation of the Primer Compositions

Compositions used in the present invention were made according to the following description and summarized in Table 1.

It has been found that the inclusion of edible, solid, insoluble particles, which may be in the form of an emulsion or dispersion, as defined by solid particulates in a liquid medium, produces improved colour intensity of printed ink on absorbent food items, such as bread products, compared to a food item printed with no primer or a solution primer absent of edible, solid, insoluble particles.

TABLE 1
Primer Formulations

| | Inv. Ex. A | Comp. Ex. B | Inv. Ex. C | Inv. Ex. D |
|---|---|---|---|---|
| | (Particulate | (Solution | (Particulate | (Particulate |
| | Primer 1) | Primer) | Primer 2) | Primer 3) |
| DI WATER | 75.33 | 95.33 | 93.33 | 93.33 |
| Polysorbate 80 | 0.2 | 0.2 | 0.2 | 0.2 |
| Capmul MCM | 0.15 | 0.15 | 0.15 | 0.15 |
| K sorbate | 0.35 | 0.35 | 0.35 | 0.35 |
| Pectin | 3.55 | 3.55 | 3.55 | 3.55 |
| Sunfoods Natural White | 20.00 | 0.00 | | |
| WL^{a} | | | | |
| 0.25% citric acid^{b} | 0.60 | 0.60 | 0.60 | 0.60 |
| Coffee Creamer Powder | — | — | 2 | — |
| Milk Powder | — | — | — | 2 |
| Total | 100.00 | 100.00 | 100.00 | 100.00 |
| ¹Initial Viscosity (cP) | 244 | 75 | 86 | 1132 |
| ²Aged Viscosity (cP) | 185 (liquid) | 100 (liquid) | 227 (liquid) | 2214 (liquid) |
| Surface tension | 34.5 dynes/cm | 26.5 dynes/cm | 31.0 dynes/cm | 34.78 dynes/cm |

^{a}Solids content of 20% in an oil and water emulsion.
^{b}0.25% (w/w) citric acid in deionized water.
¹Initial viscosity was measured within 24 hours after manufacture.
²Aged viscosity was measured 3 months after manufacture.

For Examples A, B, C, viscosity was measured using a Brookfield DVI viscometer using an LCP spindle (10 rpm) and adapter at 25° C. For Example D, viscosity was measured using a Brookfield DV-II+ viscometer (#8 spindle, 25° C., 100 rpm).
Example A (Inventive): 0.15 gram Capmul MCM, 0.2 gram Polysorbate 80, 3.55 g Pectin (citrus pectin) and 20 g of Sunfoods Natural White WL White WD20 were mixed with 75.33 gram of distilled water. The mixture was stirred on a laboratory stir plate for 1 hour at room temperature (approximately 20° C.). Potassium sorbate 0.35 g was then added with further stirring and after 10 minutes, the pH was adjusted by the addition of citric acid (0.25% w/w solution in deionized water) 0.60 g.
Example B (Comparative): 0.15 gram Capmul MCM, 0.2 gram Polysorbate 80, and 3.55 g Pectin (citrus pectin), were mixed with 95.33 gram of distilled water. The mixture was stirred on a laboratory stir plate for 60 min. at room temperature (approximately 20° C.). Potassium sorbate 0.35 g was then added with further stirring and after 10 minutes, the pH was adjusted by the addition of citric acid (0.25% w/w solution in deionized water) 0.60 g.
Example C (Inventive): 0.15 gram Capmul MCM, 0.2 gram Polysorbate 80, 3.55 g Pectin (citrus pectin), of 2 g of Coffee Creamer Powder were mixed with 93.33 gram of distilled water and then mixed using a Silverson laboratory high shear mixer for 60 minutes at room temperature (approximately 20° C.). Potassium sorbate 0.35 g was then added with further stirring and after 10 minutes, the pH was adjusted by the addition of citric acid (0.25% w/w solution in deionized water) 0.60 g.
Example D (Inventive): 0.15 gram Capmul MCM, 0.2 gram Polysorbate 80, 3.55 g Pectin (Apple Peel based), of 2 g of Dried skimmed milk were mixed with 93.33 gram of distilled water and then mixed using a Silverson laboratory high shear mixer for 60 minutes at room temperature (approximately 20° C.). Potassium sorbate 0.35 g was then added with further stirring and after 10 minutes, the pH was adjusted by the addition of citric acid (0.25% w/w solution in deionized water) 0.60 g.

The particulate primers in Table 1 were assessed 3 months after manufacture and found to be in a liquid state (not gelled). Thus, the particulate primers in Table 1 are considered as stable.

### Printing Example 1: Printing on Bread Products (Ricoh Printer)

Primers were applied using a pastry brush carried out in a manner so as to provide an approximately even layer of primer across the surface of the bread product. In the case where the primer was applied to the room temperature absorbent food article, it was air dried or force dried using hot air (100-200° C.). In the case where the primer was applied to hot/warm baked goods, it was applied within 1-3 min. of emerging from a 150-200° C. oven. In such cases, the primer dried almost instantly and did not require further drying. Print assessment was then assessed by ink jet printing the Sun Chemical FGNS-710 Brown digital edible inkjet ink using a DPM printer with a Ricoh Gen 5 print head (10 pl drop size) and implementing a syringe-based ink feed system. The food item was placed on a hand encoded platen to produce the print samples at a print drop resolution of 600 dpi×600 dpi per print pass. Either a single, a double or a triple print pass was performed. A solid block was printed to allow assessment of dry time and visual appearance of the ink. The food item was printed and then the dry time was assessed by dabbing the printed block with a lint free cloth. The printed ink was either left to air dry or was dried using a hot air dryer (100-200° C.), which produced better results. Results are shown in Table 2.

TABLE 2
Printing Example 1 Results (Ricoh)

| | Bread | | | Image |
|---|---|---|---|---|
| | Surface | | Color | Quality |
| Bread Product | Temp. | Primer | Rating² | Rating³ |
| White Bread Roll | Room temp. | none | 1 | 1 |
| White Bread Roll | Room temp. | Comp. Ex. B | 2 | 2 |
| White Bread Roll | Room temp. | Inv. Ex. A | 3 | 3 |
| White Bread Roll | Room temp. | Inv. Ex. C | 3 | 3 |
| White Bread Roll | Room temp. | Inv. Ex. D | 3 | 3 |
| White Bread Roll | 50-200° C.¹ | none | 1 | 1 |
| White Bread Roll | 50-200° C. | Comp. Ex. B | 3 | 3 |
| White Bread Roll | 50-200° C. | Inv. Ex. A | 4 | 5 |
| White Bread Roll | 50-200° C. | Inv. Ex. C | 4 | 5 |
| White Bread Roll | 50-200° C. | Inv. Ex. D | 4 | 5 |
| Brioche roll | Room temp. | none | 1 | 0 |
| Brioche roll | Room temp. | Comp. Ex. B | 2 | 1 |
| Brioche roll | Room temp. | Inv. Ex. A | 3 | 3 |
| Brioche roll | Room temp. | Inv. Ex. C | 3 | 3 |
| Brioche roll | Room temp. | Inv. Ex. D | 3 | 3 |
| Brioche roll | 50-200° C. | none | 1 | 0 |
| Brioche roll | 50-200° C. | Comp. Ex. B | 2 | 1 |
| Brioche roll | 50-200° C. | Inv. Ex. A | 4 | 4 |
| Brioche roll | 50-200° C. | Inv. Ex. C | 4 | 4 |
| Brioche roll | 50-200° C. | Inv. Ex. D | 4 | 4 |

¹Depending on the time interval after baking, application of the primer to the bread surface would be in the range of 50-200° C.
²Printed bread items were visually evaluated and ranked using the following 1-5 color rating scale:
1 = Very weak color/difficult to spot printed ink against baked bread crust.
2 = Weak color/minimal difference between printed ink and baked bread crust.
3 = Acceptable color/some difference between printed ink and baked bread crust.
4 = Acceptable color/more contrast between printed ink and baked bread crust.
5 = Strong color/easy to spot printed ink on baked bread crust.
³Printed bread items were visually evaluated and ranked using the following 1-5 image quality rating scale:
1 = Very poor print resolution with no visibly determined features and significant image breakdown
2 = Poor print resolution with few visibly determined features and significant image breakdown
3 = Acceptable print resolution with most visibly determined features and a recognizable image
4 = Acceptable print resolution with all visibly determined features present and an image with good quality
5 = Excellent print resolution with all visibly determined features present and an image with superior quality

As shown in Table 2, improved color rating and image quality rating was seen for all bread products in which the inventive primer was applied compared to bread products with the comparative primer or with no primer. Further details below.

It was noted that if the surface of the bread roll was more irregular, this made the print quality worse. The primed bread rolls did not have this problem, as the primer smoothed out surface irregularities.

Description of Results from Ricoh Print Test:
Inventive Example A showed that the inventive primer imparts much improved color rating and image quality rating on all bread products.
Comparative Example B: Exhibited inferior color rating and image quality rating on all bread products.
Comparative Printing Example: No primer was applied to the bread products resulting in poor color rating and image quality rating on all bread products.
Inventive Example C showed that the inventive primer imparts much improved color rating and image quality rating on all bread products.
Inventive Example D showed that the inventive primer imparts much improved color rating and image quality rating on all bread products.

### Printing Example 2. CMYK 4-Color Printing on Shortbread 3D Animal Shape Biscuit Products (Logojet Pro H4-2400 Printer)

Baked products were first sprayed with primer using a traditional trigger spray bottle. Spraying was carried out in a manner so as to provide an approximately even layer of primer across the surface of the bread product. The primer was then allowed to dry in air or dried using a conventional hot air source. In the case where the primer was applied to the room temperature absorbent food article, it was subsequently air dried or force dried using hot air (150-200° C.). In the case where the primer was applied to hot/warm baked goods, it was applied within 1-3 min. of emerging from a 150-200° C. oven. In such cases, the primer dried almost instantly and did not require further drying. A print assessment was performed using a Logojet Pro H4-2400 printer to print Sun Chemical Sensijet FSE edible inkjet inks (600 dpi; native & 22 pl drop size).

TABLE 3
Printed Biscuit Examples (Logojet Pro H4-2400³)

| | Hot/Cold | Inkjet | Color | Image Quality |
|---|---|---|---|---|
| Primer | Bread Surface | Inks | Rating² | Rating³ |
| none | Cold | CMYK | 2 | 4 |
| Comp. Ex. B | Cold | CMYK | 3 | 3 |
| Inv. Ex. A | Cold | CMYK | 5 | 5 |
| Inv. Ex. C | Cold | CMYK | 5 | 4 |
| Inv. Ex. D | Cold | CMYK | 5 | 5 |
| none | Hot | CMYK | 3 | 4 |
| Comp. Ex. B | Hot | CMYK | 3 | 3 |
| Inv. Ex. A | Hot | CMYK | 5 | 5 |
| Inv. Ex. C | Hot | CMYK | 4 | 4 |
| Inv. Ex. D | Hot | CMYK | 5 | 5 |

³H4 Logojet using an Epson R2400 “core” with a DX5 printhead with the following settings: Micro-Piezo; 1440 dpi; Min. droplet size - 1.5 pico litre; Max. droplet size - 21 pico litre; Tot. amount of nozzles - 1440 (8 lines × 180 nozzles); Firing frequency - 8 kHz As shown in Table 3, improved color rating and image quality rating was seen for all biscuits in which the inventive primer was applied compared to bread products with the comparative primer or with no primer. Further details below.
²Printed biscuits were visually evaluated and ranked using the following 1-5 color rating scale:
1 = Very weak color/difficult to spot printed ink against baked bread crust.
2 = Weak color/minimal difference between printed ink and baked bread crust.
3 = Acceptable color/some difference between printed ink and baked bread crust.
4 = Acceptable color/more contrast between printed ink and baked bread crust.
5 = Strong color/easy to spot printed ink on baked bread crust.
³Printed biscuits were visually evaluated and ranked using the following 1-5 image quality rating scale:
1 = Very poor print resolution with no visibly determined features and significant image breakdown
2 = Poor print resolution with few visibly determined features and significant image breakdown
3 = Acceptable print resolution with most visibly determined features and a recognizable image
4 = Acceptable print resolution with all visibly determined features present and an image with good quality
5 = Excellent print resolution with all visibly determined features present and an image with superior quality

Description of Results from Logojet Pro H4-2400 Print Test:
Inventive Example A: The printed ink exhibited improved color rating and image quality rating vs. Comparative Example B, and also exhibited a sharper image plus a glossy appearance to the print.
Comparative Example B: The printed ink exhibited inferior color rating and image quality rating vs. the Inventive Examples in addition to reduced line straightness leading to some blurriness of the image.
Comparative Example: no primer was used on the shortbread biscuit. The printed ink exhibited inferior color rating and image quality rating vs. the Inventive Examples and some blurring of the image.
Inventive Example C: The printed ink exhibited improved color rating and image quality rating vs. Comparative Example B, and also exhibited a sharper image plus a glossy appearance to the print.
Inventive Example D: The printed ink exhibited improved color rating and image quality rating vs. Comparative Example B, and also exhibited a sharper image plus a glossy appearance to the print.

1-40. (canceled)

41. A method for decorating a foodstuff, comprising:
a. providing a foodstuff base layer;
b. applying an edible liquid primer to the surface of the foodstuff, wherein the primer comprises pectin; insoluble, edible particles; and water, and wherein the primer comprises pectin and water in a ratio of from about 1:38 to about 1:12 (w/w);
c. drying the primer layer;
d. printing one or more edible inkjet inks over the top of the primer layer;
e. drying the one or more inkjet ink layers;
to produce a finished, decorated foodstuff.

42. The method of claim 41, wherein the primer has a surface tension of 25-50 dynes/cm.

43. The method of claim 41, wherein the insoluble, edible particles are derived from milk.

44. The method of claim 41, wherein the insoluble, edible particles are derived from edible carbohydrates.

45. The method of claim 44, wherein the insoluble, edible particles comprise starch.

46. The method of claim 41, wherein the insoluble, edible particles are selected from the group consisting of opacifying emulsions, coffee creamer powder, milk powder, whey powder, cheese powder, coconut powder and mixtures thereof.

47. The method of claim 41, wherein the pectin is selected from the group consisting of high methoxyl (HM) pectin, low methoxyl (LM) pectin, apple pectin, citrus pectin, amidated low methoxyl pectin, pectin NH and mixtures thereof.

48. The method of claim 41, wherein the primer dries to a transparent or translucent film.

49. The method of claim 41, further comprising applying an edible overprint varnish over the top of the inkjet ink layers and drying the overprint varnish.

50. The method of claim 41, wherein the foodstuff is an absorbent or porous article.

51. A liquid primer composition comprising:
a. pectin;
b. insoluble, edible particles; and
c. water; wherein the primer comprises pectin and water in a ratio of from about 1:38 to about 1:12 (w/w) and
wherein the composition is edible.

52. The primer of claim 51, where the pectin is selected from the group consisting of high methoxyl (HM) pectin, low methoxyl (LM) pectin, apple pectin, citrus pectin, amidated low methoxyl pectin, pectin NH and blends thereof.

53. The primer of claim 51, wherein the insoluble, edible particles are derived from milk.

54. The primer of claim 51, wherein the insoluble, edible particles are derived from edible carbohydrates.

55. The primer of claim 54, wherein the insoluble, edible particles comprise starch.

56. The primer of claim 51, where the edible particles are selected from the group consisting of coffee creamer powder, milk powder, whey powder, cheese powder, coconut powder, dispersions containing particles or oil in water emulsions and blends thereof.

57. The primer of claim 51, wherein the composition is free of a citric acid ester of mono- and diglycerides.

58. A method of pre-treating a foodstuff, comprising: applying an edible liquid composition on the foodstuff, wherein the edible liquid composition is a primer; and wherein said composition comprises pectin, insoluble edible particles and water, and wherein the primer comprises pectin and water in a ratio of from about 1:38 to about 1:12 (w/w).

59. The method according to claim 58 for pre-treating a foodstuff to improve image resolution of an image printed on the pre-treated foodstuff, wherein the pre-treated foodstuff is printed with one or more edible inks.
